(19) United States
(12) Patent Application Publication
(10) Pub. No.: US 2013/0110613 A1
(43) Pub. Date: May 2, 2013

(54) ADVERTISEMENT SYSTEM FOR INDEPENDENT SERVICE PROVIDERS

(71) Applicant: REGAIN HOLDINGS LLC, Detroit, MI (US)

(72) Inventors: CLARK EDWARD COVERT, DEARBORN, MI (US); JASON ROBERT SCOTT BEALE, WARREN, MI (US)

(73) Assignee: REGAIN HOLDINGS LLC, DETROIT, MI (US)

(21) Appl. No.: 13/719,121

(22) Filed: Dec. 18, 2012

(51) Int. Cl. G06Q 30/00

(52) U.S. Cl. CPC G06Q 30/01
USPC 705/14.39; 705/347

(57) ABSTRACT

A communication system and method between independent service providers and customers can include registering a plurality of work histories from a plurality of independent service providers, each work history being distinguishable from another work history according to a plurality of information data fields. At least one merited work history can be located corresponding to one or more search terms entered by a user and selected with respect to the plurality of information data fields of the on-line system among the registered present work history and past work history of the independent service providers. The located merited work history data of an independent service provider can be displayed using a geographic user interface. Each work history, delivered by and entered from a corresponding independent service provider to an on-line system, can include a service type, a service time period, and a service location.

### FIELD OF THE INVENTION

The invention relates to a communication system between independent service providers, each providing at least one type of goods or services to the public, and customers for the goods or services, and more particularly, an advertising system providing communication of information relating to a plurality of independent service providers as well as providing easy, quick, and reliable references to a plurality of customers in real time.

### BACKGROUND

Several systems have tried to help customers to find proper merchants when the customers want to search for specific goods or services. For example, a person who wants to buy doughnuts can search locations of stores selling doughnuts through an online search engine, such as Google, Yelp, or the like. Also, people wanting to change engine oil can search locations of merchants providing vehicle maintenance service.

Some systems have provided the ability for customers to write reviews relating to the goods or services purchased and make these customer reviews available to the public. Customer reviews generally include reviews about goods or services made by customers who previously purchased the goods or services or have an experience with the goods or services being reviewed. Customer feedback with a rating and a short description is a representative example of one type of customer review. Further, some systems provide professional reviews to the public. Professional reviews are made by a professional who may have extensive experience in a specific industry field after purchasing or using goods or services provided by merchants. These customer and professional reviews are frequently used to evaluate the goods or services provided from a merchant. The most important thing is that people can use the customer and professional reviews as a factor in making purchasing decisions for the goods or services.

However, the reliability of customer and professional reviews has been questioned. Abuses akin to ballot stuffing of favorable reviews by merchants and interested persons, or negative reviews by competitors, lead to an undermining of the reliability and credibility of reviews. Though few systems restrict users to reviewing only items purchased from that site, it is difficult to prove a customer has actually used the product the customer is reviewing. Professional reviews can also be questioned because professional reviews generally do not depart from a standard pattern and are sometimes biased in favor of certain merchants for various reasons. Such customer and professional reviews are not entirely useless, but prudent customers want to have access to easy, quick, and reliable references about merchants before purchasing goods or services. Moreover, it may be necessary for merchants to easily provide information in order to increase credibility of the merchant in the eyes of the public.

### SUMMARY

A communication system can provide for the exchange of information relating to goods and/or services between a plurality of independent service providers and a plurality of customers. The information exchanged can include past and present work histories of each independent service provider to the purchasing public. When a customer searches for an independent contractor in a selected area, the communication system can provide the customer with a work history report of each independent service provider who has a business corresponding to the goods and/or services desired in a selected geographic area.

A method for communicating information about independent service providers with customers can include registering a plurality of work histories from a plurality of independent service providers. Each work history can be reported by and entered from a corresponding independent service provider to an on-line system. Each work history data record can be distinguishable from another work history data record according to a plurality of data fields. The plurality of data fields can include a service type data field, a service time period or date data field, and a service location data field. At least one merited work history can be located corresponding to at least one user input search term selected with respect to at least one of the plurality data fields of the on-line system among the registered present work history and past work history. The located at least one merited work history of at least one independent service provider can be displayed using a geographic user interface.

An information communication system between independent service providers and customers can include an enrollment part, a search part, and an interactive part. The enrollment part allows the registration of a plurality of work histories from a plurality of independent service providers. Each work history can be reported by and entered from a corresponding independent service provider to an on-line system. Each work history can be distinguishable from another work history according to a plurality of information data fields, by way of example and not limitations, such as a service type data field, a service time period or date data field, and a service location data field. The search part allows the location of at least one merited work history corresponding to at least one user input search term selected with respect to at least one of the plurality of information data fields of the on-line system among the registered present and past work history data records. The interactive part allows the display of the located merited work history data records of at least one independent service provider using a geographic user interface.

According to above described embodiments, diverse independent service providers can upload work history data records on the communication system; and then customers can easily find a suitable candidate with respect to each individual customers needs and criteria based on keyword searches, by way of example and not limitation, such as service type, service price/estimate, service period, and location.

Other applications of the present invention will become apparent to those skilled in the art when the following description of possible modes contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a diagram showing a communication system between independent service providers and customers;

FIG. 2 is a flowchart explaining a registration process of a work history from an independent service provider in the communication system shown in FIG. 1;

FIG. 3 is a screenshot describing an exemplary interface for independent service provider in the communication system shown in FIG. 1;

FIG. 4 is a flowchart depicting a registration process of performance assessment information from an authorized customer in the communication system shown in FIG. 1;

FIG. 5 is a screenshot describing an exemplary interface for authorized customer in the communication system shown in FIG. 1;

FIG. 6 is a flowchart showing a locating process of at least one merited work history with a geographic user interface in the communication system shown in FIG. 1; and

FIG. 7 is a screenshot describing an exemplary interface for customers in the communication system shown in FIG. 1.

### DETAILED DESCRIPTION

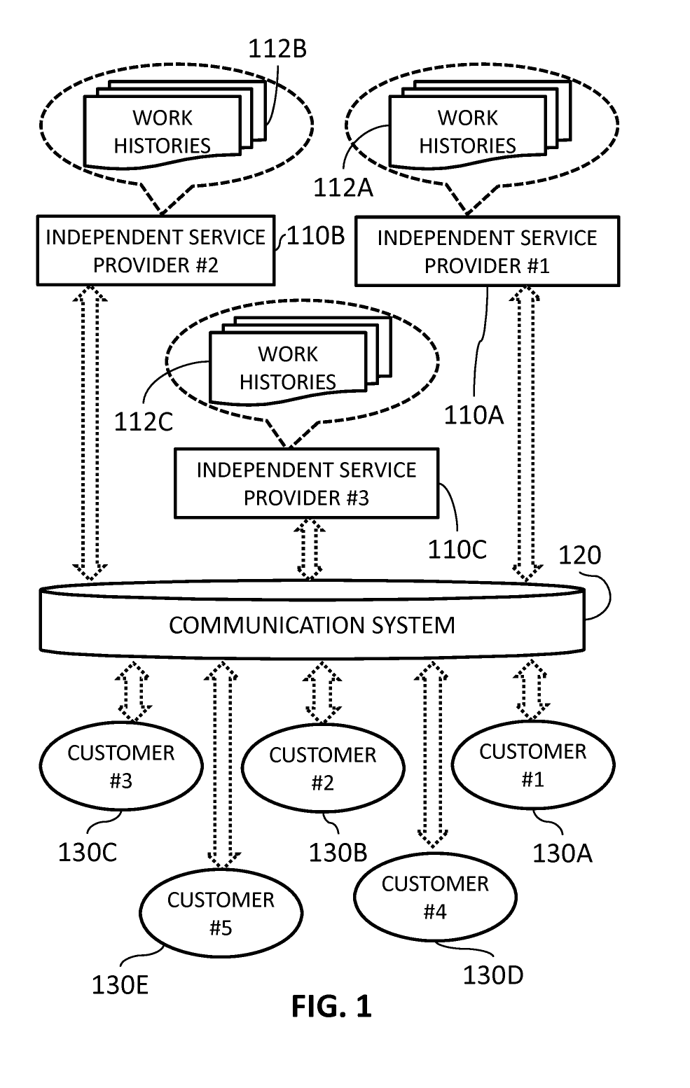

Referring now to FIG. 1, a diagram shows a communication system 120 between independent service providers 110A, 110B, 110C and customers 130A, 130B, 130C, 130D, 130E. As shown, the communication system 120 delivers information between a plurality of independent service providers 110A, 110B, 110C and a plurality of customers 130A, 130B, 130C, 130D, 130E. Each of the independent service providers 110A, 110B, 110C can provide data field information entry into corresponding work histories 112A, 112B, 112C performed by the particular independent service provider to the communication system 120. Herein, the independent service provider 110A, 110B, 110C can include a person, company, or other business entity that offers to perform one or more services for a specified period of time in a geographic regional area basis. As used herein, the term independent service provider 110A, 11B, 110C is defined to include a provider of services and/or goods. By way of example and not limitation, a local merchant who runs a retail business for providing goods and a second hand merchant, such as a swap shop, a junk shop or a pawnshop, who has a business relating transactions involving secondhand or used personal property are considered to be within the definition of an independent service provider as used herein. The independent service providers 110A, 110B, 110C can provide services to customers under a contract for particular work and/or services.

For example, there are home repair service companies such as a plumbing company, a roofing company, a construction company, a flooring/carpet installation company, an HVAC (Heating, Ventilation, Air Conditioning) repair service company, or the like. Furthermore, home care service companies, such as a lawn mowing service company, a snow plowing service company, a carpet cleaning service company, a cable service provider company, a network service provider company, a telephone service provider company, or other outsourcing companies can be also examples of the independent service providers. The internet based communication system 120 can provide an efficient channel of communication between potential customers and a wide variety of independent service providers located within a specific geographic region with respect to the potential customer, by way of example and not limitation, such as services offered by dentists, doctors, hospitals, clinics, nurses, home health care services, pharmacy services, prescription filling services, auto dealerships, auto service and repair, nanny services, babysitter services, restaurants, coffee shops, catering services, wedding planners, wedding venue services, bakery services, photography services, home appliance stores, and music/entertainment services to name only a few.

Each of the work histories 112A, 112B, 112C can include at least one of a present work history and a past work history. Each work history can be distinguishable from another work history according to one or more of a plurality of data fields located in a work history information database, which can include a service type, a service period, and a service location. For example, if the independent service provider #1 120A is a home repair service company, the independent service provider #1 120A can provide a plumbing service to a customer #1 130A and a kitchen remodeling service to a customer #2 130B. The plumbing service is a different service type from the kitchen remodeling service. If the customer #1 130A and the customer #2 130B do not live together at the same location, the plumbing service and the kitchen remodeling service are distinguishable based on different service locations identified in the plurality of data fields in a work history information database. In other words, the combined work history of independent service provider 110A, 110B, 110C create a work history information database with a plurality of data fields describing the work performed, by way of example and not limitation, such as a type of work performed, a geographic location of the work performed, and a time period during which the work was performed. Each of the independent service providers 110A, 110B, 110C can have at least one work history, unless the company is a new startup business in which case no work history would be available in the work history information database for that particular startup business.

The communication system 120 can receive information about each of the reported work histories delivered by and entered from a corresponding independent service provider. The communication system 120, in response to a particular customer 130A, 130B, 130C, 130D, 130E criteria inquiry input, can locate and display at least one merited work history meeting criteria established in the inquiry input by the corresponding customer 130A, 130B, 130C, 130D, 130E. Herein, customers 130A, 130B, 130C, 130D, 130E are people who seek information regarding independent service providers who are capable of performing services to meet the demands of the particular customer. The communication system 120 can receive any search criteria information including words, terms, or keys from an individual customer 130A, 130B, 130C, 130D, 130E. If the individual customer 130A, 130B, 130C, 130D, 130E inputs one or more search criteria terms in a search box, then the communication system 120 can locate any merited work history corresponding to the one or more search criteria terms in the work history information database including all of delivered work histories that have been reported by independent service providers 110A, 110B, 110C. Any located work histories corresponding to the one or more search criteria terms, sometimes referred to herein as “merited work history”, can be displayed using a geographic user interface. The communication system 120 can show the merited work history, as well as all work histories associated with a corresponding independent service provider, even if other work histories associated with the corresponding independent service provider do not match with the one or more search criteria terms input by a particular customer 130A, 130B, 130C, 130D, 130E. Through reviewing all of the reported work histories in the work history information database, a customer 130A, 130A, 130B, 130C, 130D, 130E can check reliability, quality, and other desirable characteristics concerning the services to be provided by a corresponding independent service provider.

For example, if a customer #3 130C seeks to obtain a reliable plumbing service company, the customer #3 130C can input the search criteria term “plumbing” in the search box to create a work history query. Then, the communication system 120 can locate any merited work history relating to the type of work “plumbing” within a predetermined default geographic search region or location and within a predetermined default time frame, and can display an identifiable mark located on a geographic user interface for any merited work history in a work history list. The communication system 120 can initially have predetermined settings for a default time frame value and for a default geographic search region value for limiting a scope of search results to be returned in response to a locating work history query. If the number or scope of search results is too large or too small, the customer can change one or more of the predetermined default settings to different values. By way of example and not limitation, the default geographic search region value can be set to include identifying at least one of a street name, a zip code, a city, a county name, and a state name. Each identifiable mark displayed corresponds to a located merited work history relating to “plumbing” in a work type data field within the plurality of data fields recorded in the work history information database. If the customer #3 130C selects one identifiable mark corresponding to work histories provided by independent service provider #2 110B, the communication system 120 can display all present work histories and past work histories associated with the independent service provider #2 110B in a comprehensive work history list. By way of example and not limitation, the communication system 120 can display a located merited work history list and a comprehensive work history list of each corresponding independent service provider through two separate popup windows on the geographic user interface, when one of the at least one identifiable mark is selected. Supplemental information can be displayed through another popup window on the geographic user interface according to a predetermined command or input from the customer, by way of example and not limitation, such as when the customer clicks on a selected work history data record. The supplemental information display can include displaying registered performance assessment information or different types of supplemental materials about a selected work history of the corresponding independent service provider reported by an authorized customer. Based on review of all the present and past work histories associated with the independent service provider #2 110B in the comprehensive work history list, the customer #3 130C can decide whether the independent service provider #2 110B is a satisfactory candidate to perform the desired services. Further, if the customer #3 130C selects another identifiable mark on the geographic user interface, she can check on and compare all of the present and past work histories corresponding to another independent service provider #3 110C.

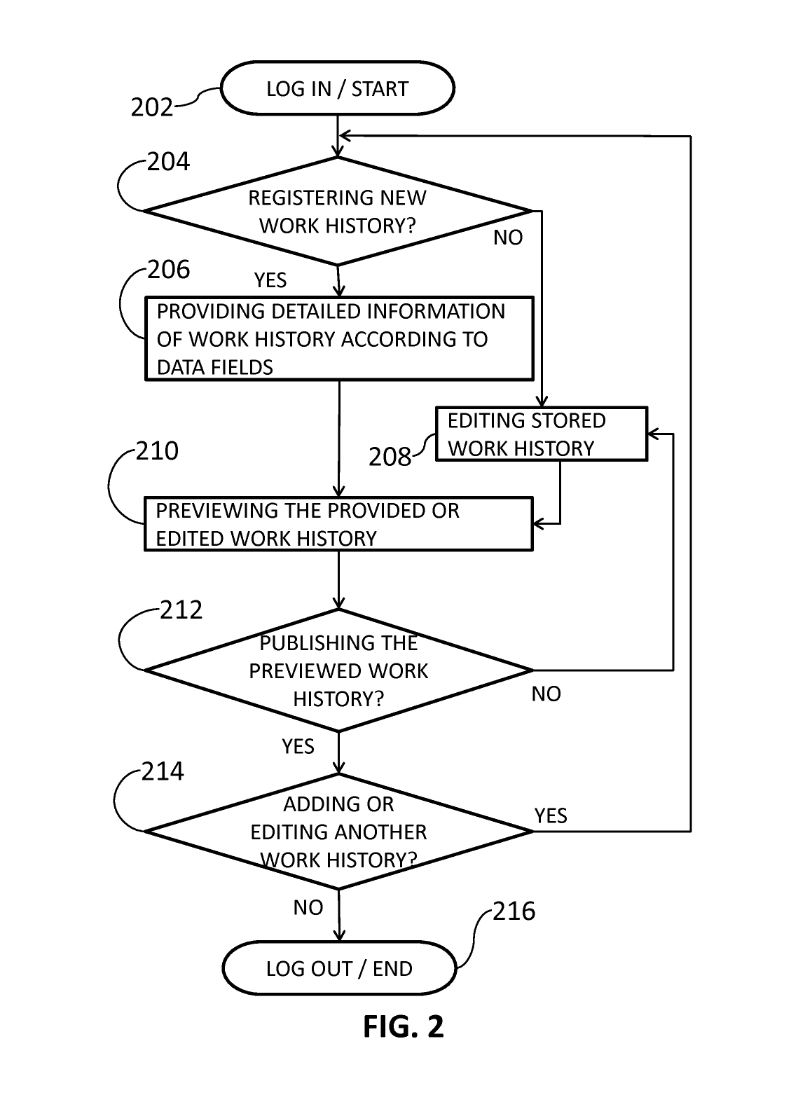

Referring now to FIG. 2, a flowchart illustrates a registration process of a work history from an independent service provider 110A, 110B, 110C in the communication system 120 shown in FIG. 1. First, in step 202, an independent service provider logins onto the communication system 120. In step 204, the independent service provider selects whether to report a new work history or to edit an existing work history stored in the work history information database of the communication system 120. If the independent service provider wants to register a new work history, the independent service provider enters detailed information about the new work history to complete some or all of the plurality of data fields in the work history information database according to a data field information entry step 206.

The data field information entry step 206 is a component of every new work history and enables distinguishing one work history from another different work history by differences in the information entered into the plurality of data fields of the work history information database by the independent service provider. Herein, the plurality of data fields can include, by way of example and not limitation, a service type, a service time period, a service location, a service price, a service estimate, a brief service description, and/or any combination thereof. The plurality of data fields can be different depending on the type of goods, services, or businesses which the independent service provider provides. The communication system 120 can include a work history information database storing a plurality of work history records entered by a plurality of independent service providers 110A, 110B, 110C. The plurality of data fields can be associated with identification tags or identifiers to be used in a database, table, or table column.

If the independent service provider does not want to register a new work history in step 204, the independent service provider can edit an existing work history record stored in the work history information database of the communication system 120 in step 208. Based on the login process, the independent service provider has authority to enter only the corresponding independent service providers own new reported work history, or edit/modify only the corresponding independent service providers own reported work histories.

After providing a new work history record in step 206 or editing an existing work history in the step 208, the independent service provider can preview the updated work history record in step 210. After previewing the information entered into the work history data fields in the step 210, the independent service provider can decide whether to publish the updated work history record. If the independent service provider decides not to publish the updated work history record in step 212, and wants to edit the updated work history, the independent service provider can return to the step 208 to edit the work history. If the independent service provider seeks to publish the updated work history in the step 212, the updated work history is entered into the work history information database which is open to public search and inspection by customers 130A, 130B, 130C, 130D, 130E shown in FIG. 1. In step 214, the communication system 120 can check on whether the independent service provider wants additional registration or editing of the work history information database. If the independent service provider wants to report an additional new work history or edit an existing work history in step 214, the independent service provider is returned to step 204. If the independent service provider does not want to report an additional new work history or edit an existing work history in step 214, the independent service provider is logged out in step 216.

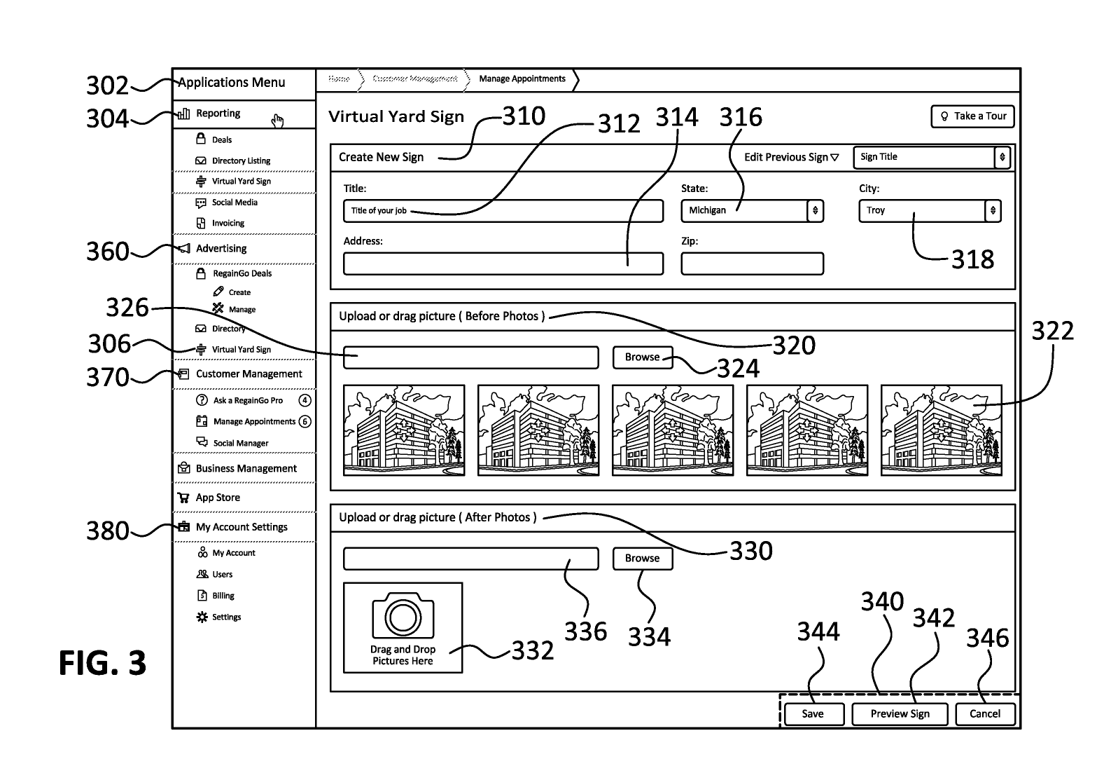

Referring now to FIG. 3, by way of example and not limitation, a screenshot illustrates a data entry interface for an independent service provider 110A, 110B, 110C in the communication system 120 shown in FIG. 1. After login of the independent service provider, the communication system 120 can provide a plurality of different interface display screens according a menu 302. The plurality of interface display screens provided by the communication system 120 can include, by way of example and not limitation, a reporting display screen section 304, an advertising display screen section 360, a customer management display screen section 370, and an account setting display screen section 380. The reporting display screen section 304 can provide the independent service provider with reports and analytics on all of the applications the independent service provider has selected to use for their business. Through the advertising display screen section 360, the independent service provider can offer a service estimate, information regarding a discount offer for services, or other information used for business dealings with potential customers. Also, the advertising display screen section 360 provides the independent service provider with the ability to register new work history information, update existing work history information, or superintend existing work history information. The customer management display screen section 370 can provide the independent service provider with a business scheduling and Question & Answer (Q&A) board display screen. Further, the independent service provider can register and maintain business contact information via the account setting display screen section 380.

The advertising display screen section 360 can include a virtual yard sign page 306 for registering new work history information. The virtual yard sign page 306 can include a new sign display screen section 310 to define work history information to be entered by the independent service provider according to the plurality of data fields, by way of example and not limitation, such as first and second information data entry window sections 320 and 330 to input and upload relevant information pertaining to a corresponding new work history, and a command box 340. The new sign display screen section 310 can include several input boxes, by way of example and not limitation, such as service title 312, address 314, state 316, city 318, and zip code. These input boxes, or data entry interfaces, can be associated with the data field information entry step 206 shown in FIG. 2.

The first information data entry window 320 can include information pertaining to a time period before services are provided, sometimes referred to herein as “before-materials”, by way of example and not limitation, such as photos or videos 322, and the second information data entry window section 330 can include information pertaining to a time period after services are provided, sometimes referred to herein as “after-materials”, by way of example and not limitation, such as photos or videos 332. Photos or videos 322, 332 can be dragged and dropped into the desired position, or a browse button 324, 334 can be provided to browse for the desired photo or video 322, 332. A text box 326, 336 can be provided for direct data input regarding the location of the desired photo or video 322, 332. A command box 340 can include one or more input buttons for delivering an instruction to the communication system 120, by way of example and not limitation, such as a preview button 342, a save button 344, and a cancel button 346. The preview button 342 can provide the independent service provider with a preview of data, by way of example and not limitation, such as a newly registered, edited, or updated independent service provider originated work history data. The previewed data can be approved for registration, publication, edited, updated, or cancelled by the independent service provider.

The advertising display screen section 360 can provide a plurality display screen interfaces for delivering information, by way of example and not limitation, such as a service estimate, a service time period, a discount option, or similar enticement or incentive to a potential new or return customer of the independent service provider. Further, the communication system 120 can provide a video coupon displayed for commercial dealing between the independent service provider and the customer/user. The video coupon can include a video describing at least one of a service and a product offered by the independent service provider, and a coupon associated with a trailing end portion of the video offering a discounted price or other enticement or incentive to the potential customer for the offered service or product.

The customer management display screen section 370 can provide a plurality of display screen interfaces for interconnecting the independent service providers with customers, by way of example and not limitation, such as one or more social media services. Further, the communication system 120 can provide a limited direct question and answer communication channel between a customer/user and a selected group of independent service providers based on service type and service location entered by the customer/user. The limited direct communication channel can allow a question from a customer/user and a response to the question to be provided by one of the selected group of the independent service providers.

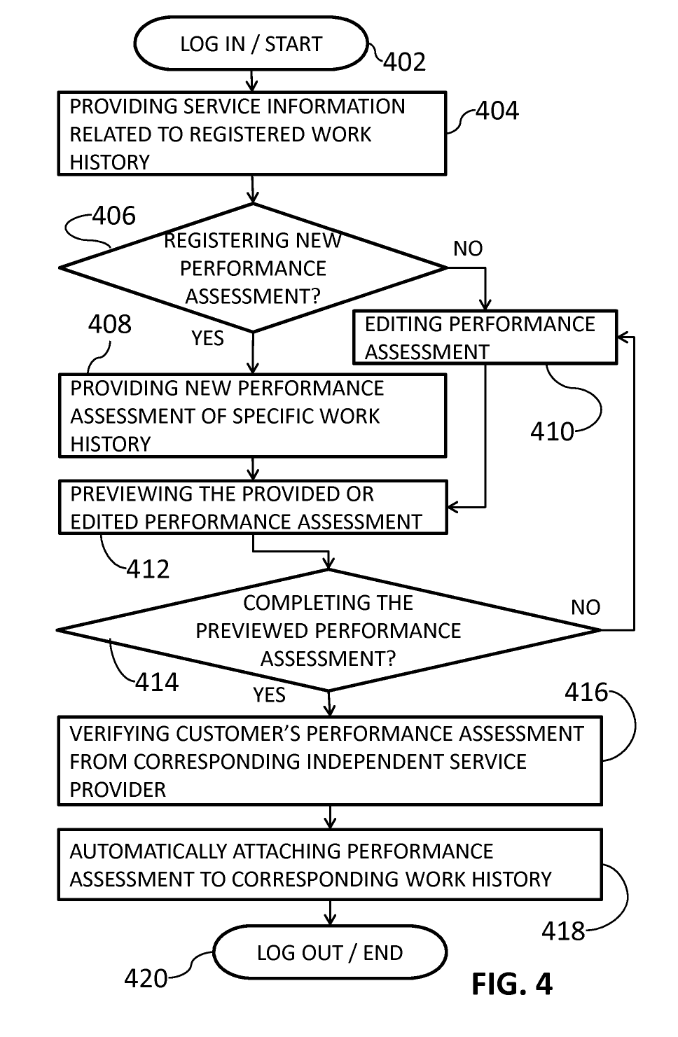

Referring now to FIG. 4, a flowchart depicts a registration process for performance assessment information from an authorized customer regarding an independent service provider 110A, 110B, 110C in the communication system 120 shown in FIG. 1. In step 402, a customer logins onto the communication system 120. In step 404, the communication system determines if the customer wants to register new performance assessment information data. If the customer wants to enter new performance assessment information data, the customer proceeds to step 408 to provide work history information data entry from the customer regarding a specific work history which had been provided by a corresponding independent service provider. If the customer does not want to enter new performance assessment information data in step 408, the customer proceeds to step 410 to edit previously entered performance assessment information stored in the communication system 120.

Performance assessment information in the communication system 120 is provided by customers 130A, 130B, 130C, 130D, 130E of the independent service provider, not by the independent service providers 110A, 110B, 110C. The communication system 120 can allow a customer to register performance assessment information about a specific independent service provider or a specific work history, only if the customer can show that the customer received such services or goods from such corresponding independent service provider. The performance assessment information can include, by way of example and not limitation, a detailed description of service provided, a rating of the independent service provider, short comments, and detailed before-materials and/or after-materials provided by the customer. The detailed description of service provided can include data relating to a service type, a service time period, and/or a service location to correlate the performance assessment information with the corresponding work history of the independent service provider. The independent service provider rating and short comments are provided by customers of the particular independent service provider. Any detailed description of service provided materials entered by a customer can include before and/or after photos or videos to depict services or goods provided from such independent service provider.

In step 408, a customer who wants to register new performance assessment information provides detailed information about a specific work history which has been previously reported by a corresponding independent service provider. In step 410, the customer who does not want to register new work history can edit performance assessment information of a specific work history stored in the communication system 120. Based on login credentials, the customer only has authority to edit or modify performance assessment information about specific work histories which have been provided by a corresponding independent service provider to the customer.

After providing data field information entry in step 408 for a new performance assessment information, or editing any previously provided performance assessment information regarding a work history in step 410, the customer can preview an updated performance assessment information in step 412. After previewing the performance assessment information in the step 412, the customer can decide whether the updated performance assessment information should be published in step 414. When the customer wants to edit the updated performance assessment information about a specific work history prior to publication, the customer can return to step 410 to edit the performance assessment information. If the customer decides to publish the updated performance assessment information for a specific work history, the performance assessment information is entered into the performance assessment information data fields for the particular work history information data stored in the database which is open to public search and inspection by customers 130A, 130B, 130C, 130D, 130E shown in FIG. 1. In other words, step 414 allows the communication system 120 to check whether the customer wants to complete the preview and publication of the updated performance assessment information.

In step 416, after performance assessment information is updated or registered, the communication system 120 delivers such performance assessment information to the corresponding independent service provider for completion of a verification process. The verification process is performed to prevent customer's performance assessment information from being distorted and to increase the reliability of performance assessment information. The corresponding independent service provider can determine whether the delivered performance assessment information is associated with a work history for the particular independent service provider. If adverse performance assessment information is submitted by a customer, the independent service provider has an opportunity to address any issues raised in the performance assessment information with the customer in order to seek a revised or updated performance assessment information submission from the particular customer.

In step 418, when the verification process is completed, a performance assessment information report from a customer is automatically attached to the corresponding work history of the particular independent service provider. Otherwise, if there is any incorrect or wrong data included in a performance assessment information report from a customer, such performance assessment information can be rejected for publication prior to being made available to the public because of low reliability. When submission of the performance assessment information report is completed by the customer, the customer is logged out of the communication system 120 in step 420.

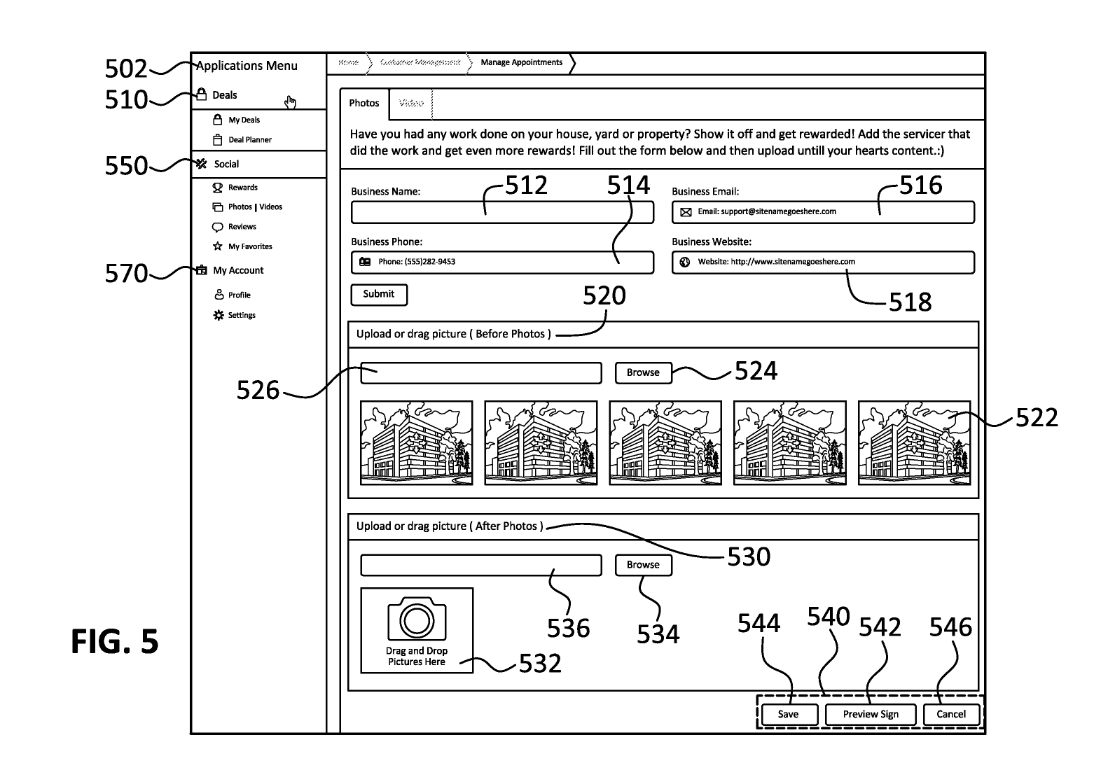

Referring now to FIG. 5, by way of example and not limitation, a screenshot illustrates an interface for an authorized customer in the communication system 120 shown in FIG. 1. After the customer logs into the communication system 120, the communication system 120 can provide a plurality of interface display screens according a menu 502. The plurality of interface display screens of the communication system 120 can include a purchase display screen section 510, a social interact display screen section 550, and an account setting display screen section 570. The purchase display screen section 510 can record information relating to a purchase, discount, incentive, credit, or other transaction of a customer. The social interact display screen section 550 can provide a customer with tools for interacting socially by managing a review, a reward option, a coupon, or the like relating to the customer. Further, a customer can register and maintain residential or business contact information via the account setting display screen section 570.

Through the purchase display screen section 510, a customer can provide information relating to a purchase of goods or services from independent service providers from the communication system 120. In the purchase display screen section 510, a detailed data section can be used to describe business information relating to an independent service provider that has provided a customer with goods or services, and first and second information data entry window sections 520 and 530 to upload material relating to a purchase of goods or services. By way of example and not limitation, the detailed data section can include data entry input boxes 512, 514, 516, 518 for reporting a business name and business contact information of an independent service provider offering to sell goods or services purchased by the customer. By way of example and not limitation, the business contact information provided by a customer relating to an independent service provider can include data registered through a business name data entry input box 512, a business phone number data entry input box 514, a business email data entry input box 516, a business website data entry input box 518. Further, the first information data entry window section 520 can include before-materials, such as photos or videos 522, and the second information data entry window section 530 can include after-materials, such as photos or videos 532. Photos or videos 522, 532 can be dragged and dropped into the desired position, or a browse button 524, 534 can be provided to browse for the desired photo or video 522, 532. A text box 526, 536 can be provided for direct data input regarding the location of the desired photo or video 522, 532. A command box 540 can include one or more input buttons for delivering an instruction to the communication system 120, by way of example and not limitation, such as a preview button 542, a save button 544, and a cancel button 546. The preview button 542 can provide the customer with a preview of a newly registered, edited, or updated customer originated work history data.

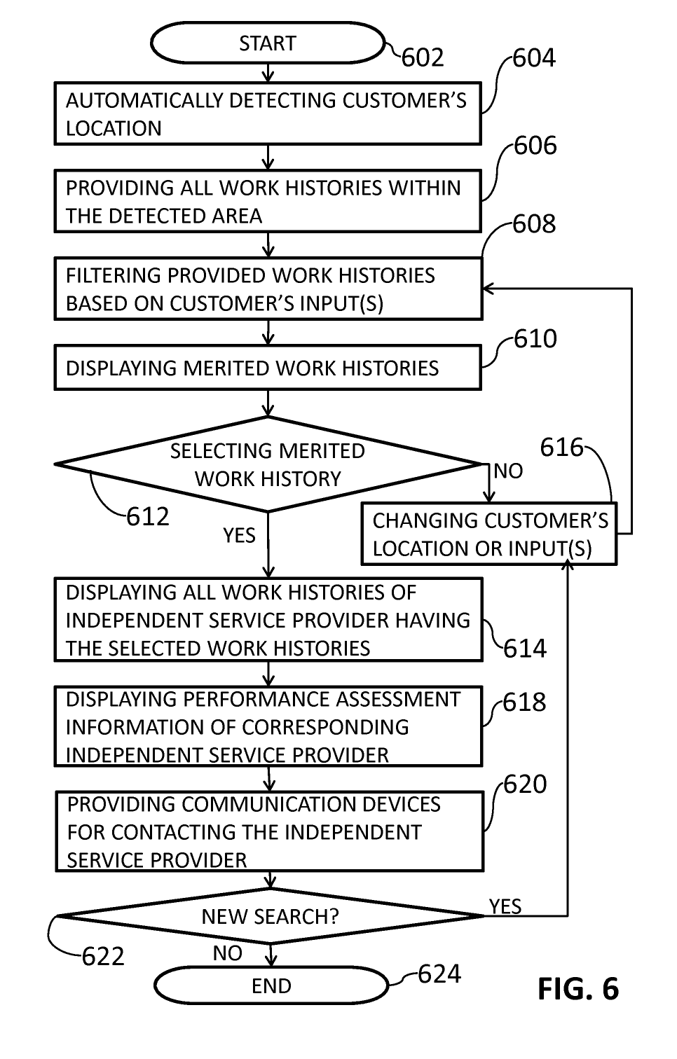

Referring now to FIG. 6, a flowchart shows a locating process of at least one merited work history with a geographic user interface in the communication system 120 shown in FIG. 1. In step 602, the communication system 120, automatically detects a location of a customer 130A, 130B, 130C, 130D, 130E when the customer accesses the communication system 120, by way of example and not limitation, such as a web site on a wide area network (WAN) or local area network (LAN). By way of example and not limitation, the communication system 120 can use an IP address, HTML5 Geolocation, or GPS information of the customer to determine the location of the customer. In step 604, the communication system 120 locates all work histories within a predetermined region based on the location of the customer. The communication system 120 can display the located work histories with a geographic user interface, such as a map. Each work history can be displayed as an identifiable mark on the geographic user interface or map.

In step 608, when a customer inputs one or more search terms, the communication system 120 can filter out the previously registered or reported work histories provided by independent service providers and customers based on the search terms specified by the customer. Initially, the communication system 120 can filter out work histories within the predetermined region based on the geographic location of the customer. If the number of filtered work histories available, based on the initial geographic limitation size centered on the geographic location of the customer, is not sufficient to provide the customer with a usable geographic user interface, the communication system 120 can adjust the geographic level or range of the predetermined geographic region to be displayed for the geographic user interface. After filtering work histories based on the one or more search terms entered by the customer, the communication system 120 displays at least one merited work history in step 610 on the geographic user interface. If plurality merited work histories are displayed on the geographic user interface, the communication system 120 determines the priority based on an amount of supplement materials, by way of example and not limitation, such as before-materials, after-materials, and customer ratings, registered in the communication system 120 associated with the each of the merited work histories. The supplemental materials for deciding the priority can depend on the type of services or goods provided by independent service providers. By way of example and not limitation, the supplemental materials can include a photo, a sketch, a design, a plan, and a description. As an independent service provider incorporates more types of supplemental materials, the priority for the related work history data record becomes higher, because more types of supplemental materials can be reviewed by a potential customer describing services or goods offered by the independent service provider enhancing the ability of the potential customer to more accurately and reliably gauge the desirability of doing business with the independent service provider.

In step 612, a customer seeking to find suitable independent service provider can select an identifiable mark on the geographic user interface or map corresponding to at least one merited work history shown on the geographic user interface. If there is no work history associated with the identifiable mark (i.e. a startup business), the communication system 120 displays a suitable message to the customer. If there is no work history associated with the search terms entered by the customer, the communication system 120 displays a suitable message to the customer, by way of example and not limitation, such as through a pop up window overlaying the geographic interface. In that case, the customer is prompted for data entry input relating to a time frame and/or an acceptable search region for locating and filtering records in the work history information database associated with the communication system 120 in step 616. The acceptable search region can be defined based on a street name, a zip code, a city name, a county name, a radial distance from a current customer location, a radial distance from a customer defined location, or the like. The time frame can be defined by calculating a time period of at least one of a period of days, a period of months, or a period of years backward from a present date. After appropriate data information entry in step 616, the customer is returned to step 608.

In step 612, if the customer selects an identifiable mark on the geographic user interface or map corresponding to at least one merited work history, the communication system 120 can provide all work histories associated with the corresponding independent service provider having the selected work history in step 614. For this display screen or pop up window, all of the registered or reported work histories for the corresponding independent service provider can be shown without any regional or time frame limitation. As a result, the customer can obtain detailed historical information regarding the corresponding independent service provider to determine if the independent service provider meets the requirements of the customer regarding reliability, quality, and other criteria prior to entering into a business transaction with the independent service provider.

In step 618, a customer can input a predetermined command to request the communication system 120 to display performance assessment information of the corresponding independent service provider. Further, the communication system 120 can provide communication options (i.e. address, phone number, website) to a customer for contacting the corresponding independent service provider in step 620. In step 622, the communication system 120 determines if a customer wants to conduct a new search. If the customer wants to conduct a new search in step 622, the customer is returned to step 616 for inputting one or more search terms, or changing a time frame and a search region. If the customer does not want to conduct a new search in step 622, the customer is logged out in step 624.

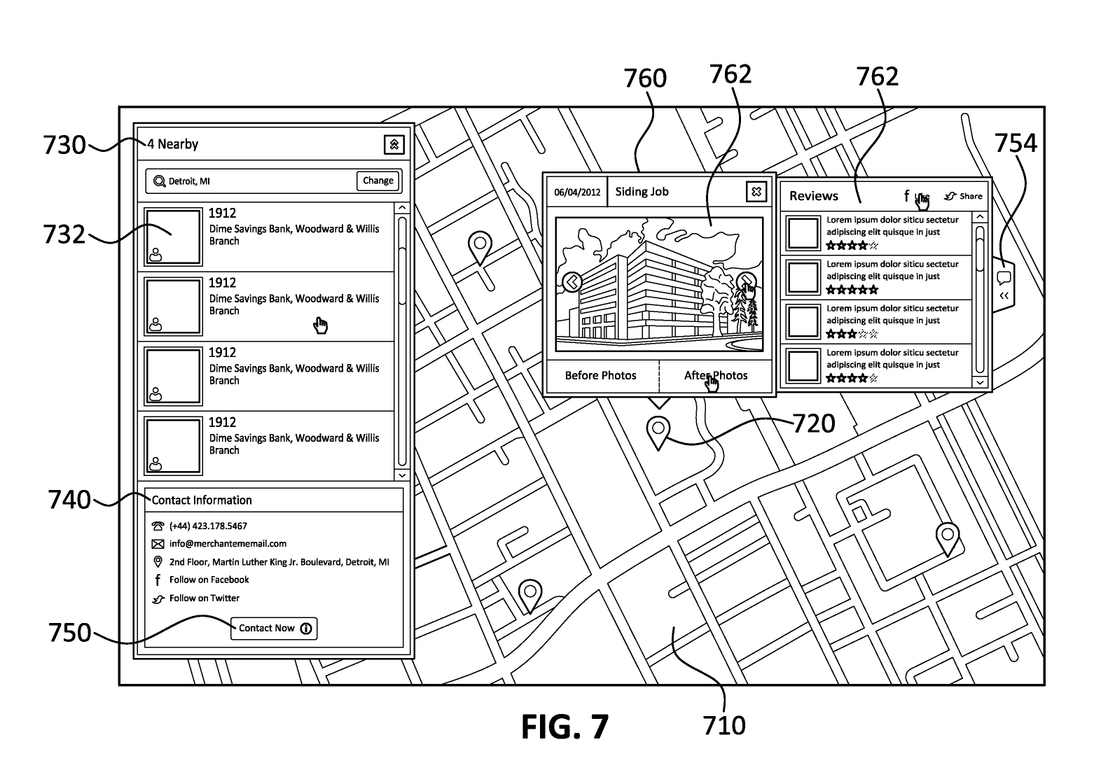

Referring now to FIG. 7, a screenshot illustrates an exemplary geographic user interface for customers 130A, 130B, 130C, 130D, 130E in the communication system 120 shown in FIG. 1. The communication system 120 can provide detailed information regarding independent service providers 110A, 110B, 110C to customers with a geographic user interface 710. Referring to FIG. 7, a variety of information about various independent service providers can be shown on the geographic user interface 710, e.g., a map. After filtering to locate at least one merited work history based on a location of a customer and/or one or more search terms, the communication system 120 can display the located merited work histories by using an identifiable mark 720 on the map of the geographic user interface 710. An identifiable mark 720 used in the communication system 120 can include multiple meanings. By way of example and not limitation, several colors for the identifiable marks 720 can be used as a supplemental identifier of the priority or of a review rating from previous customers. Additionally, the identifiable marks 720 can have a digital number representing a priority or a review rating from previous customers.

When a customer selects an identifiable mark 720 corresponding to one merited work history, the communication system 120 can provide simplified information relating to the selected work history through a mark triggered popup window 760. The popup window 760 can include more detailed information relating to the selected work history associated with the mark 720, such as before-materials and after-materials, by way of example and not limitation, such as pictures and/or videos 762. In addition, the communication system 120 can provide a listing of all of the registered and reported work histories of the corresponding independent service provider through another separate popup listing window 730. The popup listing window 730 can include a work history section 732, business contact information 740, and a contact button 750.

The work histories listed in the work history section 732 are not limited on any regional geographic basis and/or any time frame basis. If a plurality work histories are included in the listing, a service location and a service time period can be a factor for determining the priority in the listing between the various displayed work histories, i.e., which work history is displayed at the top of listing. If a plurality of work histories are included in the listing, priority between work histories in the listing can be decided based on a degree of supplemental materials existing in the work history data record or the completeness of the description about each work history, by way of example and not limitation, such as detailed written description, supplemental before-materials, supplemental after-materials, including photos, videos, customer ratings, and the like. By way of example and not limitation, a priority value can be determined based on a degree of supplemental materials associated with the located merited work history, wherein the supplemental materials can include at least one of a photo, a sketch, a design, a plan, and a description, such that a higher cumulative priority value can be assigned for each type of supplemental materials included in the located merited work history.

The business contact information 740 in popup window 730 can include a telephone number, an email address, a physical address, other information relating to social media connections, and the like. The business contact information 740 can be managed through the account setting display screen section 380 shown in FIG. 3. A contact button 750 can be provided to allow several types of communication options to be presented for use between a customer and the corresponding independent service provider. The communication options or devices can include an email, a voice mail, or other audio or audiovisual devices available to a customer.

Popup window 760 can include simplified information about each work history associated with the corresponding identifiable mark 720. Another pop-out slide window 780 can be triggered when a customer activates a predetermined command to the communication system 120 via a push button 754. Pop-out slide window 780 can include performance assessment information such as a rating, a short review, and prior customer comments about each work history or the corresponding independent service provider.

As is apparent from the above descriptions, the communication system 120 between independent service providers 110A, 110B, 110C and customers 130A, 130B, 130C, 130D, 130E provides a real-time registration and search capability within an on-line system. A plurality of independent service providers 110A, 110B, 110C can register work history with the communication system via computers or mobile devices in an internet environment. By way of example and not limitation, the communication system 120 can support transaction-based applications on local area networks (LANs), wide area networks (WANs), the Internet and intranets. Also, the communication system 120 can be accessed from computers with an Internet, intranet, LAN, or WAN connection, by way of example and not limitation, such as a desktop computer, a notebook computer, a laptop computer, a home computer, a wearable computer, an internet enabled television, or a tablet computer, as well as many mobile devices which are capable of Internet, intranet, LAN, or WAN access, by way of example and not limitation, such as a smart phone, a personal digital assistant (PDA), or a portable multimedia player (PMP). Also, a plurality of customers 130A, 130B, 130C, 130D, 130E can seek to find suitable and reliable independent service providers relevant to the particular demands and criteria of each individual customer via computers or mobile devices in an internet environment.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for communicating information about independent service providers with customers comprising:
registering a plurality of work histories from a plurality of independent service providers, each work history reported by and entered from a corresponding independent service provider to an on-line system, wherein each work history includes a work history data record, each work history data record distinguishable from another work history data record according to a plurality of information data fields including at least in part service type and service location;
locating at least one merited work history data record corresponding to at least one user input search term selected with respect to at least one of the plurality of information data fields of the on-line system among the registered plurality of work histories; and
displaying information from the located at least one merited work history data record of at least one independent service provider with a geographic user interface.

2. The method of claim 1, wherein the registering the plurality of work histories further comprises:
providing a data entry interface corresponding to the plurality of information data fields for each work history data record to be recorded in the on-line system;
providing a preview of data entered in the data entry interface for the plurality of information data fields for each work history data record; and
allowing the corresponding independent service provider to edit and publish the previewed data entered in the data entry interface for the plurality of information data fields for each work history data record in the on-line system.

3. The method of claim 1, wherein the plurality of information data fields further include at least one of a service price, a service time period, a service estimate, and a brief service description.

4. The method of claim 1 further comprising:
registering assessment information with respect to a selected work history from an authorized customer, wherein the assessment information is included in the plurality of information data fields of a work history data record.

5. The method of claim 1, wherein the locating at least one merited work history further comprises:
initially setting a default time frame value and a default geographic search region value for limiting a scope of search results to be returned in response to a locating work history query.

6. The method of claim 5, wherein the default geographic search region value further comprises:
identifying at least one of a street name, a zip code, a city, a county name, and a state name.

7. The method of claim 5, wherein the default time frame value further comprises:
calculating a time period of at least one of a period of days, a period of months, and a period of years backward from a present date.

8. The method of claim 1, wherein the displaying the located at least one merited work history further comprises:
displaying at least one identifiable mark on the geographic user interface, each identifiable mark corresponding to a located merited work history;
displaying a located merited work history list and a comprehensive work history list of each corresponding independent service provider through two separate popup windows on the geographic user interface, when one of the at least one identifiable mark is selected; and
displaying supplemental information through another popup window on the geographic user interface according to a predetermined command.

9. The method of claim 8, wherein the displaying supplemental information further comprises:
displaying registered performance assessment information about a selected work history of the corresponding independent service provider reported by an authorized customer.

10. The method of claim 8 further comprising:
if a plurality of identifiable marks are displayed, ranking located merited work history data records by a priority value.

11. The method of claim 10 further comprising:
determining the priority value based on a degree of supplemental materials associated with the located merited work history, wherein the supplemental materials include at least one of a photo, a sketch, a design, a plan, and a description.

12. The method of claim 11 further comprising:
assigning a higher cumulative priority value for each type of supplemental materials included in the located merited work history.

13. The method of claim 1 further comprising:
providing real-time registration and search with the on-line system.

14. The method of claim 1 further comprising:
displaying a limited question and answer communication channel between a customer and a selected group of the independent service providers based on service type and service location entered by the customer.

15. The method of claim 14, further comprising:
terminating the limited question and answer communication channel when a response to a question from a customer is provided by one of the selected group of the independent service providers.

16. The method of claim 1 further comprising:
displaying a video coupon for commercial dealing between the independent service provider and the customer, wherein the video coupon includes a video describing at least one of a service and a product offered by the independent service provider and a coupon associated with a trailing end portion of the video offering a discounted price for the service or product offered.

17. An information communication system between independent service providers and customers comprising:
an enrollment part allowing registration of a plurality of work histories from a plurality of independent service providers, each work history reported by and entered from a corresponding independent service providers to an on-line system, wherein each work history includes a work history data record, each work history being distinguishable from another work history according to a plurality of information data fields including at least in part a service type and a service location;
a search part allowing location of at least one merited work history data record corresponding to at least one user input search term selected with respect to at least one of the plurality of information data fields of the on-line system among the work history data records associated with the on-line system; and
an interactive part allowing display of any merited work history data records of at least one independent service provider with a geographic user interface.

18. The information communication system of claim 17 further comprising:
a data field for registering assessment information to a selected work history data record from an authorized customer.

19. The information communication system of claim 17 further comprising:
a limited communication channel between a customer and a selected group of the independent service providers based on service type and service location entered by the customer allowing a question from a customer and a response to the question to be provided by one of the selected group of the independent service providers.

20. The information communication system of claim 17 further comprising:
a video coupon displayed for commercial dealing between the independent service provider and the customer, wherein the video coupon includes a video describing at least one of a service and a product offered by the independent service provider and a coupon associated with a trailing end portion of the video offering a discounted price for the service or product offered.
